(19) United States
(12) Patent Application Publication
(10) Pub. No.: US 2003/0011137 A1
(43) Pub. Date: Jan. 16, 2003

(54) Seals for internal combustion engines

(76) Inventor: G. Douglas Dubose, Lubbock, TX (US)

Correspondence Address: PETER D KEEFE, KEEFE AND ASSOCIATES, 24405 GRATIOT AVENUE, EASTPOINTE, MI, 48021

(21) Appl. No.: 10/237,350

(22) Filed: Sep. 9, 2002

Related U.S. Application Data
(62) Division of application No. 09/804,786, filed on Mar. 13, 2001, now abandoned.
(60) Provisional application No. 60/191,624, filed on Mar. 23, 2000.

(51) Int. Cl. F16J 9/06; F16J 15/16

(52) U.S. Cl. 277/500

(57) ABSTRACT

A seal configuration for both reciprocating pistons and for rotating valves of internal combustion engines. A first embodiment, applicable to reciprocating pistons, provides minimum crevice volume (MCV). The MCV seal assembly according to the present invention, which replaces, at least, a conventional top piston ring and its annular groove, includes an annular groove in the piston, a wavy spring at the bottom of the annular groove and an MCV seal received in the annular groove and biased outwardly by the wavy spring, wherein the MCV seal assembly is configured and oriented so as to minimize the crevice volume above the MCV seal, wherein the spring biasing ensures an excellent sealing of the MCV seal to the cylinder wall. A second embodiment, applicable to rotary valves, particularly a variable orbital aperture (VOA) valve system, a plurality of VOA seal assemblies are provided, each including a groove, a wavy spring at the bottom of the groove and a VOA seal received in the groove and biased outwardly by the wavy spring so as to seal the orbiter relative to at least one of the upper head, lower head and the one or more floaters, and the seal the at least one floater relative to at least one of the upper head, the lower head and the orbiter. Each MCV seal and VOA seal is preferably coated with a low friction, high endurance coating, as for example metal oxides applied by a plasma gun.

### CROSS-REFERENCE TO RELATED APPLICATIONS

The present application is a divisional application of Ser. No. 09/804,786, filed on Mar. 13, 2001, which application is presently pending and is a continuation of provisional patent application Ser. No. 60/191,624, filed on Mar. 23, 2000, which application is now lapsed.

### BACKGROUND OF THE INVENTION

1. Field of the Invention

The present invention relates to seals used to seal moving components undergoing sliding motion relative to stationary components of an internal combustion engine, particularly seals used to seal pistons and rotary valves.

2. Description of the Prior Art:

A. Piston Sealing

Crevices in the combustion chamber of an internal combustion engine can be defined as small volumes with narrow entrances into which the combustion flame is unable to penetrate. As cylinder pressure increases during the compression stroke and combustion process, fuel-air mixture is forced into these crevice volumes. The large ratio of surface area to volume of the crevice quenches any flame that attempts to enter the crevice. Thus, the fuel trapped in a crevice does not burn. Problematically, therefore, when the exhaust process begins and the cylinder pressure drops rapidly, the unburned fuel is pulled from the crevices and exhausted from the internal combustion engine. These unburned hydrocarbons provide a major contribution to the overall hydrocarbon emissions from the internal combustion engine.

Turning now to FIGS. 1 through 5, crevice volumes and their affect on hydrocarbon emissions will be discussed. In this regard, a portion of this information is taken from Internal Combustion Engine Fundamentals by John B. Heywood, McGraw-Hill, Inc., N.Y., dated 1988, pages 360-365 and 604-608, hereby incorporated herein by reference, and the reader is earnestly solicited to consult this reference for further elaboration.

FIG. 1 depicts the upper cylinder environment of a conventional internal combustion engine, wherein a piston 10 reciprocates in a cylinder 12, poppet valves 14 and 16 regulate gas passage into and out of the cylinder and a spark plug 18 initiates ignition of a fuel/air mixture in the combustion chamber 20.

In that compression produced by combustion must be contained in the combustion chamber 20 during the power stroke, the piston 10 must be sealed against the cylinder wall 12a, yet the sliding friction must be kept minimal. The conventional solution has been to utilize one of more annular piston rings 22 which seat in an annular groove 24 (see FIG. 2) and which abut at a contact surface 22a with the cylinder wall 12a. A gap g is formed in the piston rings 22, as shown at FIG. 3, to allow the piston rings to be set into the annular groove 24.

There are several crevice volumes in the combustion chamber of a typical internal combustion engine. Typical crevice volumes include the spaces between the piston, piston rings, and cylinder wall; the threads around the end of the spark plug; the space around the spark plug center electrode; the crevices around the intake and exhaust valves; and the head gasket crevice. For a typical “V-6” internal combustion engine, for example, the volume above the top ring is the largest single crevice volume (almost one-third of the total crevice volume) and the sum of the crevices related to the ring-piston-cylinder interfaces accounts for over 80% of the total crevice volume.

FIGS. 1 and 2 (and referentially in combination with FIG. 3) show the crevice volumes related to the ring-piston-cylinder interfaces, wherein the crevice volume 1 is located above the first ring (between planes a and b), crevice volume 2 (behind the first ring) is located between planes b and c, crevice volume 3 (between the first and second rings) is located between planes c and d, crevice volume 4 is located behind the second piston ring, crevice volume 5 is located below plane d, and crevice volumes 6 and 7 are located at the gap g of the first and second piston rings 22.

The crevice volume 1 above the top ring dominates all the others, and if crevice volume 1 could be reduced to near zero, then it is estimated that the hydrocarbon emissions would decrease by at least 50%. It should also be noted that reducing the crevice volume 1 (not necessarily to zero) and increasing the crevice volume 6 so that the gap g is larger than 0.18 mm would also provide a viable solution to reduce total hydrocarbon emissions.

FEV Engine Technology of Auburn Hills, Mich. published a Tech Brief (“Flame Propagation into Top Land and Crevice Region and Its Influence on HC Emissions in SI Engines”, Tech Brief, Society of Automotive Engineers Exposition Issue, FEV Engine Technology, Auburn Hills, Mich., 1996) which was distributed at the 1996 SAE Congress in Detroit. This paper described a project to measure the effect of modifying the top surface of a piston on engine HC emissions. FIG. 4 shows the proposed modifications made to a piston 10′, wherein the piston is shown in the “production” version, having no modification; and is further shown alternatively having a “modification I” shown by line 24; having a “modification II” shown by line 26; or having a “modification III” shown by line 28. FIG. 5 shows the resulting hydrocarbon emissions improvement for each of the aforesaid piston modifications in relation to the “production” version of the piston 10′. The FEV paper provides further evidence that reducing the ratio of surface area to volume for a crevice reduces the HC emissions from the engine.

The background information recounted above indicates the importance of two crevice volume criteria: 1) reducing the crevice volume above the top piston ring in internal combustion engines, and 2) widening the gap entrance to any crevice volume that is present.

Accordingly, what remains needed is a top piston ring seal configured to optimally achieve the above indicated two crevice volume criteria.

B. Rotary Valve Sealing

Rotary valves are conventionally configured in the form of either a disc (as for example described in U.S. Pat. No. 4,418,658) or a cylinder (as for example described in U.S. Pat. No. 4,815,428), wherein the rotary valve rotates with respect to each seat of one or more ports of the machine. The rotary valve is provided with one or more apertures which, as the rotary valve rotates via a drive connected in time with the drive shaft of the machine, periodically align with a respective seat of one or more ports of a chamber of the machine. Whenever alignment occurs, the respective port and rotary valve aperture provide unobstructed aspiration of the chamber.

A vastly improved rotary valve system which provides fully dynamic control over valve events, including timing, duration and centerline thereof, as well as effective port area and effective port shape is described in U.S. Pat. No. 5,558,049, to G. Douglas Dubose, issued on Sep. 24, 1996, the disclosure of which is hereby incorporated herein by reference, and which disclosure hereinafter is referred to simply as “Dubose”.

The variable orbital aperture (VOA) valve system of Dubose includes a rotary valve in the form of a primary disc, hereinafter referred to as an “orbiter” having primary intake and exhaust apertures provided therein for sealing with the head and periodically aligning with intake and exhaust ports therein to thereby periodically aspirate the combustion chamber. The orbiter is connected by a linkage to the crank (or drive) shaft of the internal combustion engine, and turns at typically one-half the crank (or drive) shaft speed. The variable orbital aperture valve system according to the present invention further includes at least one secondary disc, hereinafter referred to as a “floater” having a secondary aperture therein which, depending upon the selected placement of the secondary aperture with respect to the respective intake or exhaust port, the aforesaid alignment with the primary intake or exhaust aperture of the orbiter is thereby modified. The selected position of the secondary aperture with respect to a respective intake or exhaust port is effected by an actuator, such as for example a stepper motor, turning the floater a selected number of degrees under computer control, such as for example by the ECM. The orbiter is sealed with respect to the one or more floaters, and the orbiter and the one or more floaters are collectively sealed with respect to the head.

Referring now to FIG. 13, shown is an exemplary head assembly 100 of a reciprocating internal combustion engine which is equipped with a VOA valve system 102 according to Dubose. The head assembly 100 includes a lower head 110, and upper head 150, an orbiter 104 and a single floater 106 located at the intake port 108 of the head 110. The orbiter 104 rotates with respect to the upper and lower heads and the floater 106 is selectively rotatably movable with respect to the upper and lower heads. The lower head 110 has an exhaust port 112 and also has the aforementioned intake port 108 to thereby provide periodic aspiration of a combustion chamber 114, timed according to the reciprocation of the piston 116 in the cylinder 118. The aforesaid aspiration is determined by a primary intake aperture 120 (see FIG. 17) in the orbiter 104 periodically aligning with the intake port 108 and by a primary exhaust aperture 122 in the orbiter periodically aligning with the exhaust port 112. The floater 106 (see FIG. 18) is provided with a secondary aperture 124 which is selectively positionable with respect to the intake port 108 by rotative movement thereof. Accordingly, the aforementioned alignment of the primary intake aperture 120 of the orbiter 104 with the intake port 108 is modifiable even while the engine is running by selected positioning of the secondary aperture 124 of the floater 106 with respect to the intake port.

According to Dubose, the intake port 108 and exhaust port 112 are shown by way of example only and the shape and placement thereof may be varied for engineering reasons. The lower head 110 has an orbiter seat 126 which is recessed an amount that approximates the thickness of the orbiter 104. An annular groove 128 is provided at the periphery of the orbiter seat 126 for sealingly receiving therein an annular lip 130 of the orbiter 104 which is located at the periphery thereof. An orbiter boss 132 is centrally located in the orbiter seat 126 for sealingly guiding the orbiter 104 at a boss hole 134 centrally located therein. A threaded spark plug hole 136 is provided in the lower head 110 centrally with respect to the orbiter boss 132 for threadably receiving therein a spark plug 138. Finally according to Dubose, an orbiter drive gear recess is provided in the lower head 110 adjacent the annular groove 128 so that an orbiter drive gear may be located thereat and gearingly mesh with teeth on the periphery of the orbiter 104.

Dubose indicates that the upper head 150 is removably connected to the lower head 110, such as by bolting, whereby the orbiter 104, the floater 106, and associated components may be installed and serviced. The upper head 150 also provides a conduit for an intake manifold 152 and intake manifold port 154 thereof which is positioned directly opposite the intake port 108 and is shaped identically therewith. The upper head 150 further provides a conduit for an exhaust manifold 156 and exhaust manifold port 158 thereof which is positioned directly opposite the exhaust port 112 and is shaped identically therewith. An access cavity 135 is provided therein for the spark plug 138.

According to Dubose, the floater 106 is provided with the aforesaid secondary aperture 124, which is depicted by way of example only wherein the shape and placement thereof may be varied for engineering reasons. The upper head 150 is provided with a floater seat 160 which is recessed an amount that approximates the thickness of the floater 106. An annular groove 162 is provided at the periphery of the floater seat 160 for sealingly receiving therein an annular lip 164 of the floater 106 which is located at the periphery thereof. A floater boss 166 centrally defines the inner limit of the floater seat 160 for sealingly guiding the floater 106 at a boss hole 168 centrally located therein. The floater 106 and the orbiter 104 are mutually sealingly abutted with respect to each other, and the head 110 and the upper head 150 are collectively mutually sealingly abutted with respect to the orbiter 104 and floater 106.

According to Dubose, the floater 106 is provided with teeth at the periphery thereof. An actuator, preferably in the form of an electrically powered stepper motor, includes a floater drive gear which gearingly meshes with the teeth of the floater 106. The stepper motor (or other actuator) is located in an actuator recess provided in the upper head 150, and is operably controlled by a computerized control system, the nature of which is detailed in Dubose. As indicated hereinabove, the secondary aperture 124 is shaped and positioned so as to be alignable over the intake port 108, and selectively render the intake port open or partially occluded depending upon movement of the floater 106 with respect thereto by actuation of the stepper motor.

While a nearly limitless arrangement of floaters, orbiters and combustion chamber exhaust and intake ports can be imagined, three primary exemplifications are noted by Dubose:

a) a head having a single intake port and a single exhaust port, an orbiter with a single primary exhaust aperture and a single primary intake aperture, and a single floater having a secondary aperture located at the intake port;

b) a head having a single intake port and a single exhaust port, an orbiter with a single primary exhaust aperture and a single primary intake aperture, and dual floaters, each having a secondary aperture located at the intake port; and

c) a head having a single intake port and a single exhaust port, an orbiter with a single primary exhaust aperture and a single primary intake aperture, and two floaters, one floater having a secondary aperture located at the exhaust port, and the other floater having a secondary aperture located at the intake port.

In general, the VOA valve system of Dubose is in the form of an original or retrofit aspiration control component of a fluid processing machine, wherein the machine has at least one fluid processing chamber, each chamber having at least one port through which fluid passes into and out of the chamber, wherein the VOA valve system is characterized as:

an orbiter having at least one primary aperture therein;

means for mounting the orbiter adjacent a chamber of the fluid processing machine to thereby mount the orbiter rotatably with respect to the chamber in sealingly interfaced relation with respect to the at least one port;

means for rotating the orbiter with respect to the chamber to thereby provide periodic alignment of the at least one primary aperture with respect to the at least one port;

at least one floater having a secondary aperture therein;

means for mounting the at least one floater adjacent the orbiter to thereby mount the at least one floater movably in sealingly interfaced relation with respect to said orbiter and the at least one port; and

means for selectively moving the at least one floater with respect to the at least one port so that the secondary aperture is selectively aligned with respect thereto;

wherein fluid passes through the at least one port when the at least one primary aperture of the orbiter aligns therewith, and wherein the alignment of the at least one primary aperture with respect to the at least one port is selectively modified by the selective movement of the at least one floater due to repositioning of the at least one secondary aperture thereof with respect to the at least one port.

Further, the VOA valve system according to Dubose preferably includes a computerized control system (fancifully referred to herein as a “software cam”) for controlling selective movement of the one or more floaters, characterized by:

actuator means for selectively moving the at least one floater with respect to the at least one port; and

computer control means for controlling actuation of the actuator means to thereby selectively align the secondary aperture with respect to the at least port responsive to selected operating conditions of the machine.

Dubose discloses the following aspects of the VOA valve system.

The rotation speed of the orbiter may be different than one-half the crankshaft speed, depending for example on the number of intake and exhaust ports in the head and/or whether the engine is operating on four or two cycle operation. In the case of a retrofit installation, the cam shaft location can be used to provide a main orbiter drive shaft, from which individual orbiter drive shafts are drivingly engaged to thereby drive each orbiter by respective meshing engagement with a toothed periphery thereof. The orbiter may be supported by a center pivot or by a sealing surface near its periphery. The orbiter can be concentric with the cylinder or it can be offset to allow space for a conventional spark plug and possibly for an in-cylinder fuel injector. With the orbiter supported at the edge thereof, the center can be left open to provide access for the spark plug and/or a fuel injector. The orbiter can rotate in a plane perpendicular to the cylinder axis or it can be positioned at an arbitrary angle to the cylinder axis. The orbiter may be flat or provided with any surface of revolution, such as a cup shape. While an orbiter with a curvature may be more difficult to fabricate than a flat one, it would have the advantage of stiffness and thereby provide a potentially better seal under high pressure conditions.

There are at least two basic primary aperture configurations for the orbiter. In a first configuration, the primary exhaust aperture is located adjacent the axis of rotation of the orbiter, while the primary intake aperture is located further from the axis of rotation; the intake and exhaust ports are similarly located so that the primary intake and exhaust apertures uniquely align respectively with the intake and exhaust ports and a circular seal prevents commingling of the gases therebetween. In a second configuration, the orbiter is provided with a single primary aperture which serially aligns with the intake and exhaust ports; due to sealing requirements to prevent gas commingling, this configuration may be best suited for high performance engines.

In certain internal combustion engines (or, for that matter, any fluid processing machines having similar operational characteristics, such as pumps) there may be more or less than two ports for aspiration. Indeed, at a minimum, the fluid processing chamber of the machine could have only one port for periodic aspiration, the orbiter could have only one primary aperture and would rotate at a speed appropriate to provide the necessary periodicity of port alignment for correctly timed intake and exhaust aspiration, and the floater could have one secondary aperture selectively positionable with respect to the single port.

The floaters are located either above, below, or both above and below the orbiter. The floaters preferably move rotatably, but may rather move linearly or otherwise move, either side of a centerline position; with respect to rotative movement, typically only a few degrees either side of the centerline is necessary. By rotating the floater to thereby relocate the secondary aperture with respect to either the intake or exhaust port, the alignment of the respective primary aperture of the orbiter with the port is altered. Alteration of alignment can include adjustment of the port area and shape, valve event duration, valve event timing (opening and/or closing), the centerline of the valve event, and overlap of the valve event with respect to adjacent stroke portions of the cycle. The floaters can be dynamically controlled by the ECM using one or more stepper motors or other electric or pneumatic actuators. Production internal combustion engines would typically have one intake port floater, whereas developmental engines may have one or two floaters on each of the intake and exhaust ports so as to provide fine-tune adjustment of operation of a particular engine, whereupon a single floater would be installed at the intake port on the optimized production version of the particular engine. Because the floaters are controlled by the ECM, a software instruction, which as mentioned hereinabove is fancifully referred to herein as a “software cam”, is stored in memory thereof to thereby effect floater movement in response to sensed engine conditions, and provide a wide range of performance options.

Dubose points out that the orbiter and the floaters are preferably constructed of a wear resistant metal, ceramic or metal coated ceramic. Adequate sealing and inherent lubrication are provided, for example, by an interface of ceramic surfaces with respect to carbon impregnated metal surfaces. In this regard, the materials selected for all wearing surfaces of the orbiter, floaters, and head, must be corrosion resistant, have a low coefficient of friction, and have high strength even when hot. Materials can include ceramics, oxide ceramics, carbides, nitrides, and “superalloys” having a predominately nickel composition.

What remains needed is a seal which provides long wear and excellent sealing of the orbiter relative to the heads and the floater(s) relative to the heads and the orbiter.

### SUMMARY OF THE INVENTION

The present invention is a seal configuration for both reciprocating pistons and for rotating valves of internal combustion engines.

According to a first embodiment of the present invention, applicable to reciprocating pistons, a minimum crevice volume (MCV) is provided, wherein an MCV seal assembly according to the present invention replaces a conventional top piston ring and its annular groove. The MCV seal assembly includes an annular groove in the piston, a wavy spring at the bottom of the annular groove and an MCV seal received in the annular groove and biased outwardly by the wavy spring, wherein the MCV seal assembly is configured and oriented so as to minimize the crevice volume above the MCV seal, wherein the spring biasing ensures an excellent sealing of the MCV seal to the cylinder wall.

According to a second embodiment of the present invention applicable to rotary valves, particularly the variable orbital aperture (VOA) valve system of Dubose, a plurality of VOA seal assemblies are provided, each including a groove, a wavy spring at the bottom of the groove and a VOA seal received in the groove and biased outwardly by the wavy spring so as to seal the orbiter relative to the upper and lower heads and the one or more floaters, and the one or more floaters with respect to the orbiter and the upper and lower heads.

Each VOA seal, and preferably any moving surface in contact therewith, is preferably coated with a low friction, high endurance coating, as for example metal oxides applied by a plasma gun; this same coating may be applied to the MCV seals, as well.

Accordingly, it is an object of the present invention to provide a minimum crevice volume (MCV) seal assembly for a piston of an internal combustion engine with provides reduction of hydrocarbon emissions by minimizing crevice volume above the MCV seal assembly.

It is an additional object of the present invention to provide a plurality of VOA seal assemblies for a variable orbital aperture valve system which provides sealing between the upper and lower heads, the orbiter and the one or more floaters thereof.

These, and additional objects, advantages, features, and benefits of the present invention will become apparent from the following specification.

### BRIEF DESCRIPTION OF THE DRAWINGS

FIG. 1 is a partly sectional side view of a conventional piston and cylinder arrangement of a prior art internal combustion engine.

FIG. 2 is a sectional side view of a prior art piston ring arrangement for the piston shown in FIG. 1.

FIG. 3 is a broken-away perspective view of a prior art piston ring of FIGS. 1 and 2, showing in particular the gap thereof.

FIG. 4 is a sectional side view of a conventional piston and cylinder, depicting various proposed prior art modifications thereto to reduce hydrocarbon emissions.

FIG. 5 is a prior art graphical depiction of the hydrocarbon (HC) emission as pertains to the structural modifications of the piston of FIG. 4.

FIG. 6 is a partly sectional side view of a piston and cylinder arrangement having a minimum crevice volume (MCV) seal assembly according to the present invention for an internal combustion engine.

FIG. 7 is a partly sectional side view of a minimum cavity volume seal according to a first form of the MCV seal assembly.

FIG. 8 is a partly sectional side view of a minimum cavity volume seal according to a second form of the MCV seal assembly.

FIG. 9 is a partly sectional side view of a minimum cavity volume seal according to third form of the MCV seal assembly.

FIG. 10 is a partly sectional side view of a minimum cavity volume seal according to a fourth form of the MCV seal assembly.

FIG. 11 is a partly cross-sectional view of the first form of the MCV seal assembly, shown in operation with respect to a piston and a cylinder and seen along line 11-11 of FIG. 7.

FIG. 12 is a perspective view of the first form of the MCV seal assembly.

FIG. 13 is a partly sectional side view of an internal combustion engine equipped with a variable orbital aperture (VOA) valve system of Dubose.

FIG. 14 is a partly sectional side view of an internal combustion engine equipped with a VOA valve system of Dubose and provided with VOA seal assemblies according to the present invention.

FIG. 15 is a plan view of a lower head of the internal combustion engine of FIG. 14.

FIG. 16 is a plan view of an upper head of the internal combustion engine of FIG. 14.

FIG. 17 is a plan view of an orbiter of the internal combustion engine of FIG. 14.

FIG. 18 is a plan view of a floater of the internal combustion engine of FIG. 14.

FIG. 19 is a partly sectional side view of a first form of the VOA seal assembly.

FIG. 20 is a partly sectional side view of a second form of the VOA seal assembly.

FIG. 21 is a partly sectional side view of a third form of the VOA seal assembly.

FIGS. 22A and 22B depict operation of a VOA seal assembly according, showing how blow-past of compression gas from the combustion chamber is prevented.

FIG. 23 is a partly cross-section view of an interlock of two mutually transverse VOA seal assemblies.

FIGS. 24A through 24C depict an alternative configurations of the VOA seal assembly.

FIG. 25 is a partly sectional side view of an internal combustion engine equipped with a variable orbital aperture valve system of Dubose having two floaters and provided with VOA seal assemblies according to the present invention.

FIG. 26 is a plan view of a second floater of the internal combustion engine of FIG. 25.

### DETAILED DESCRIPTION OF THE PREFERRED EMBODIMENT

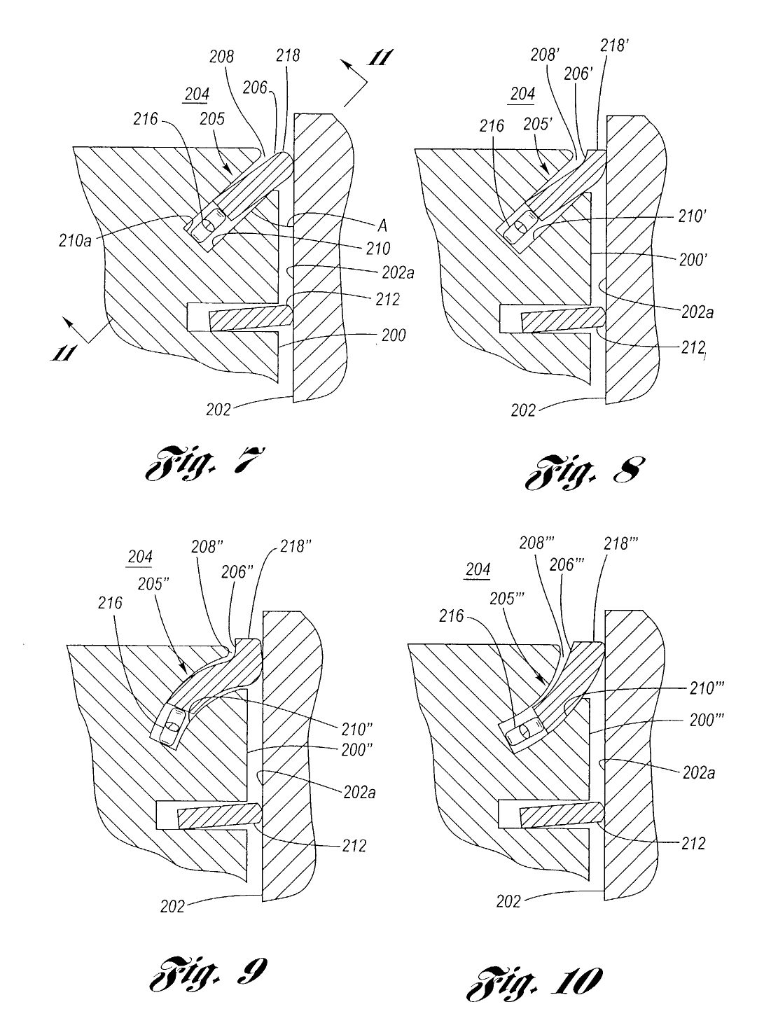

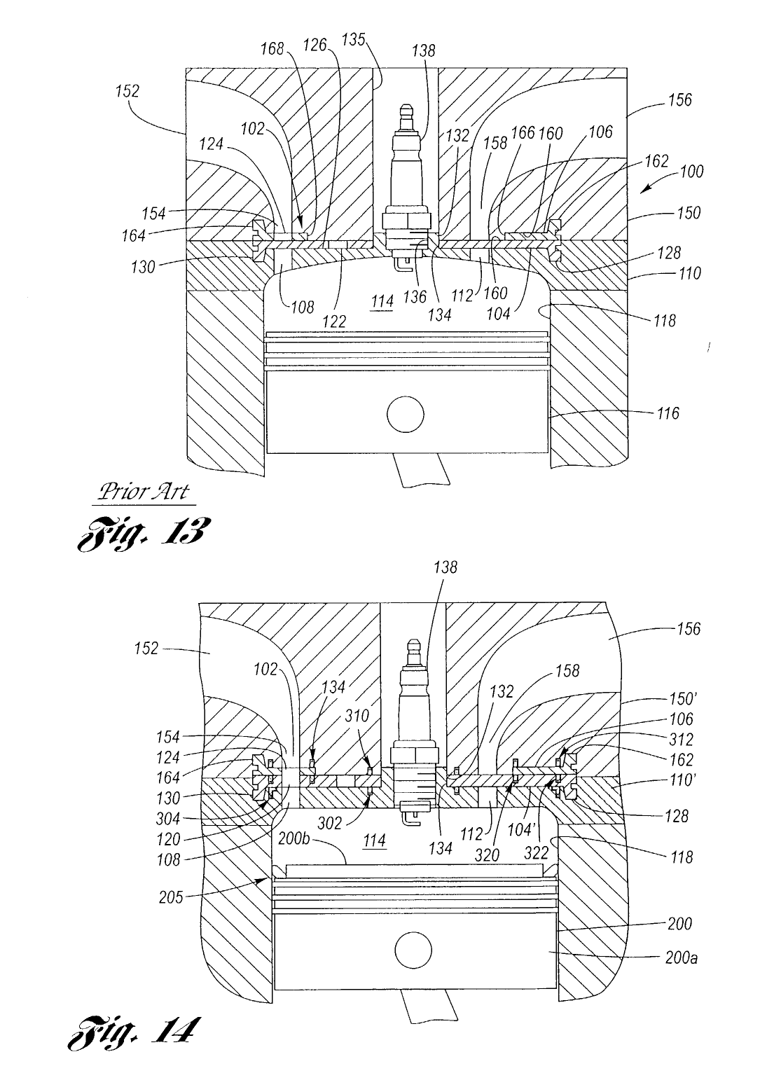

FIGS. 6 through 12 depict a minimum crevice volume (MCV) seal assembly according to the first embodiment of the present invention.

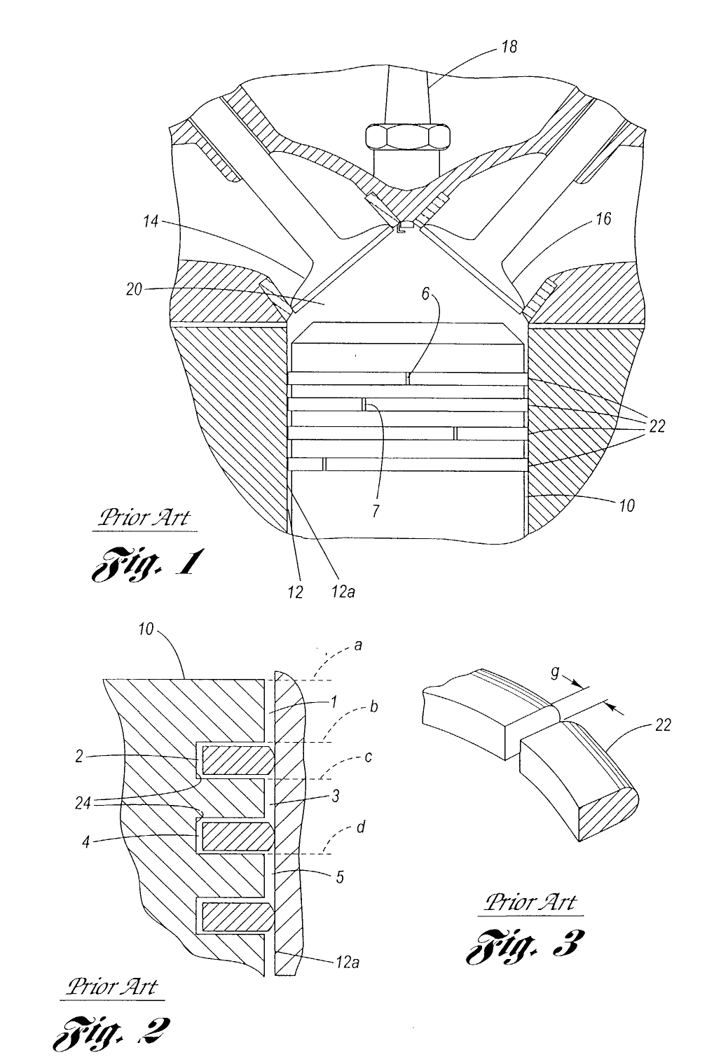

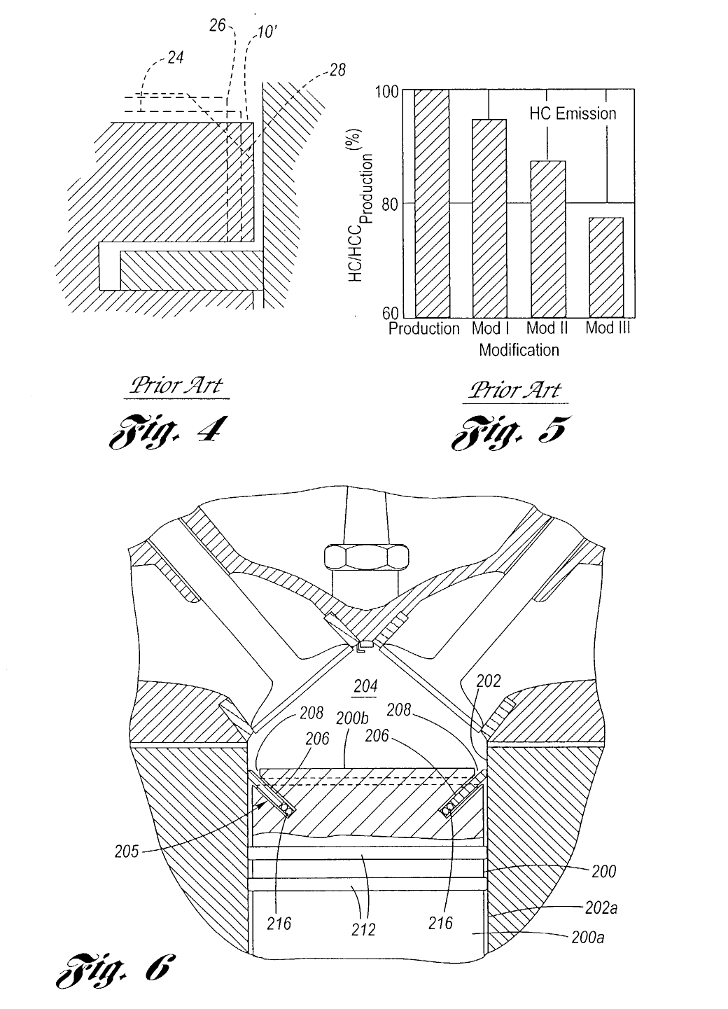

FIG. 6 depicts a piston 200 having an annular piston wall 200a and an upper face 200b, cylinder 202 having a cylinder wall 202a, and combustion chamber 204 analogous to that of FIG. 1, but now including, at what would conventionally be the top piston ring, an MCV seal assembly 205. The MCV seal assembly 205 includes an annular groove 210 (see FIG. 7), a wavy spring 216 located at a bottom 210a (again, see FIG. 7) of the annular groove and an MCV seal 206 received in the annular groove and outwardly biased by the wavy spring. Note that the crevice volume 208 located between the annular piston wall 200a and the cylinder wall 202a adjacent the upper face 200b is small and that the opening of the crevice volume into the combustion chamber 204 is wide so as not to prevent a flame from entering the crevice. As further shown at FIG. 7 the annular groove 210 is oriented at a groove angle A which is non-perpendicular with respect to the cylinder wall 202a, as for example about forty-five degrees. The other, lower, piston rings 212 (if present) may be conventional, or may be segmented with a wavy spring therebehind analogous to seal 206 and wavy spring 216 in preferably a horizontal orientation.

As depicted at FIG. 12, the MCV seal 206 is composed of at least two, preferably three, segments, 206a, 206b, 206c that have interlocking abutments 206d so as to allow the MCV seal to float between its annular groove 210 and the cylinder wall 202a. As shown at FIGS. 6, 7 and 11, the MCV seal 206 is supported by the wavy spring 216 located at the bottom 210a of the annular groove 210. Thus, the MCV seal 206 is not dependent on its own spring tension to seal against the cylinder wall 202a (as a conventional piston ring does), but rather uses the wavy spring 216 to ensure uniform contact with the cylinder wall 202a and better sealing than provided by conventional piston rings. However, the wavy spring 216 should not need to provide sealing force, rather it will ensure that the MCV seal 206 is firmly against the cylinder wall 202a so that combustion pressure, during the power stroke, can provide the sealing force. The wavy spring 216 must also ensure that dynamic forces during intake, compression, and exhaust strokes do not unseat the MCV seal 200 from contact with the cylinder wall 202a.

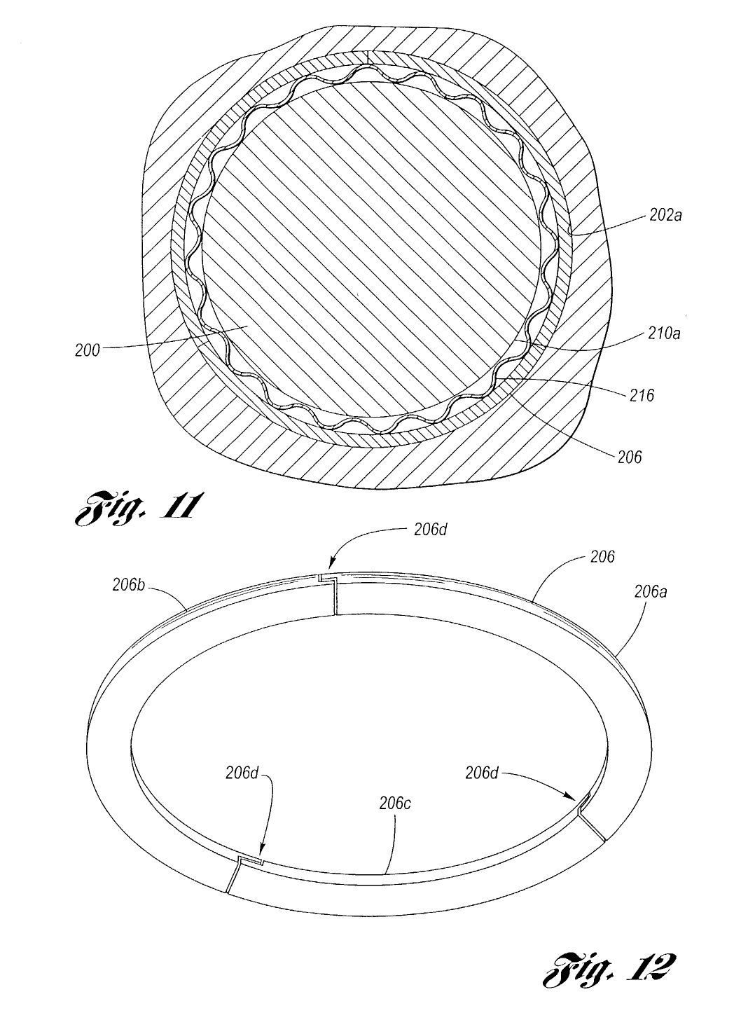

FIGS. 8, 9 and 10 depict alternative configurations of the MCV seal assemblies 205′, 205″, 205′″ which include respective MCV seals 206′, 206″, 206′″, and corresponding annular grooves 210′, 210″, 210′″ and wavy springs 216 respectively therefor. There can be structural and/or dynamic advantages to curving the annular slot either up or down. It is important that the net force on the MCV seal be such that it stays in contact with the cylinder wall 202a. For example, at FIG. 8, a received portion of the MCV seal 206′ is straight, and an exposed portion thereof is curved; at FIG. 9, a received portion of the MCV seal 206″ is curved similar to the groove 210″ and an exposed portion of the MCV seal 206″ is oppositely curved; and at FIG. 10, both the groove 210′″ and the entire MCV seal 206′″ are similarly curved. There will be pressure forces on the top and inside of the MCV seal and there will be the biasing force of the wavy spring 216 which tends to push the MCV seal out of its annular groove and force it against the cylinder wall 202a.

Both hand calculations and finite-element predictions performed by AlliedSignal at the DOE Kansas City Plant in Kansas City, Mo. show that proper shaping of the upper edge 218, 218′, 218″, 218′″ of the MCV seal can provide appropriate forces thereon which tends to seat it well against the cylinder wall 202a.

While a 45 degree groove angle A was mentioned hereinabove, it is possible that other angles, for example between about 30 degrees and about 60 degrees, may provide a suitable orientation of the MCV seal 206. In addition, curved grooves as shown at FIGS. 9 and 10 can also provide an advantage; however, they would be more difficult and more expensive to machine in the piston.

The advantages of the MCV seal assembly include the following.

1. Reduction of the crevice volume above the MCV seal and associated reduction of HC emissions.

2. Provision of a better seal between the MCV seal and the cylinder wall, particularly during piston rock near top dead center and bottom dead center.

3. Provision of cylinder pressure on the top side of the MCV seal in order to ensure that the MCV seal seals against the cylinder wall.

4. The MCV seal could obviate the lower piston rings typically included on pistons in production engines.

The MCV seals can be machined from cast steel as are conventional piston rings, however, this is an expensive procedure. It is preferred that the MCV seal segments be made from powder metallurgy processes and the wavy spring be made from stainless steel wire formed into the spring in a manner similar to that used to manufacture conventional wavy springs.

While a four stroke spark ignition internal combustion engine has been described in association with the MCV seal assemblies, they may be utilized in other internal combustion engines, as for example two stroke engines and diesel engines.

Lastly, the MCV seals may be provided with a low friction coating, as described hereinbelow, although since conventional oil lubrication is provided by the internal combustion engine, such a coating may not be needed.

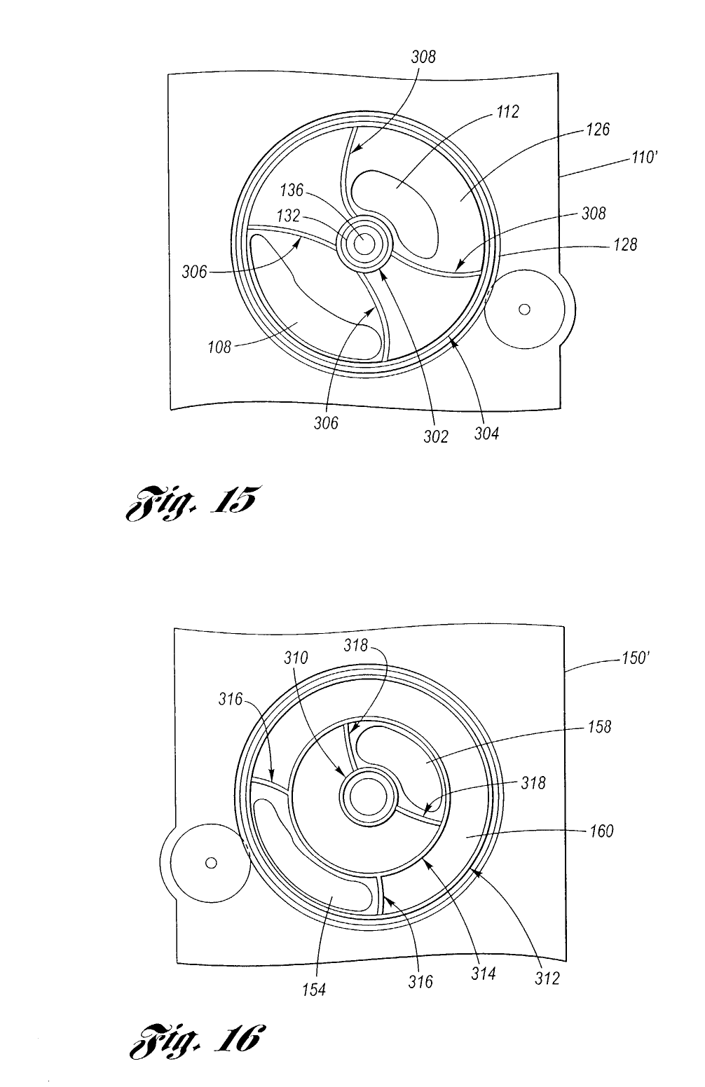

Turning attention now to FIGS. 14 through 26 VOA seal assemblies according to a second embodiment of the present invention will be detailed.

FIG. 14 depicts the embodiment shown at FIG. 13 now incorporating a number of VOA seal assemblies. The numeral designations of FIG. 13 are carried over to FIG. 14; a redescription thereof is omitted for the sake of brevity, except: the piston 200 is provided with the MCV seal assembly 205; the orbiter 104′, the lower head 110′ and the upper head 150′ are now modified to include respective VOA seal assemblies, as will be detailed hereinbelow.

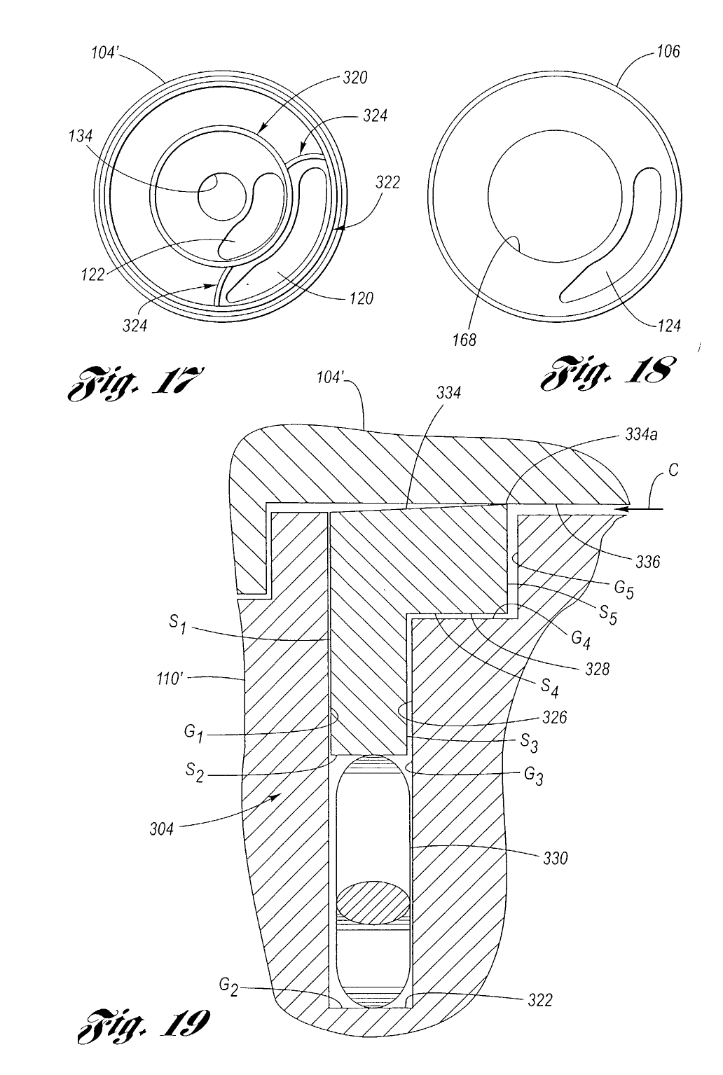

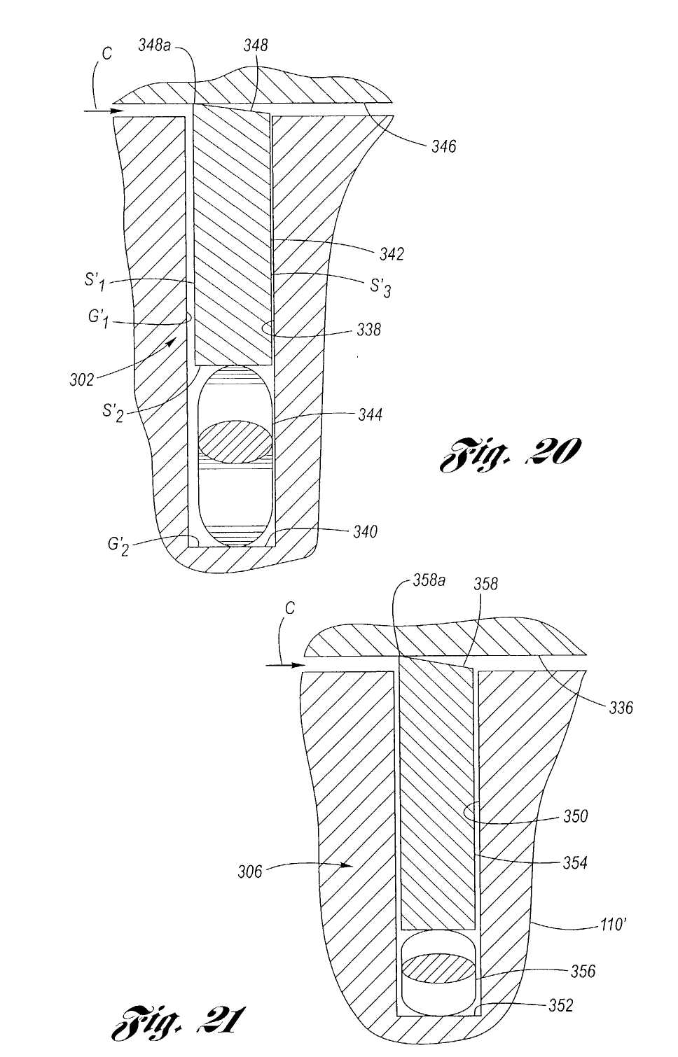

As shown at FIG. 15, the lower head 110′ includes a first annular VOA seal assembly 304, a second annular VOA seal assembly 302, a pair of first radial VOA seal assemblies 306 and a pair of second radial VOA seal assemblies 308. As shown at FIG. 16, the upper head 150′ includes a third annular VOA seal assembly 310, a fourth annular VOA seal assembly 312, a fifth annular VOA seal assembly 314, a pair of third radial VOA seal assemblies 316 and a pair of fourth radial VOA seal assemblies 318. As shown at FIG. 17, the orbiter 104′ includes a sixth annular VOA seal assembly 320, a seventh annular VOA seal assembly 322, and a pair of fifth radial VOA seal assemblies 324. FIG. 18 depicts the floater 106, which, in this example of carrying out the invention, has no VOA seal assemblies, although it can be provided with VOA seal assemblies. Preferred configurations of the VOA seal assemblies are depicted at FIGS. 19 through 21, wherein seal grooves are preferably located in the top and bottom cylinder heads and floater(s), although seal grooves could be placed in the orbiter.

A cross-sectional configuration of the preferred first annular VOA seal assembly 304 is depicted at FIG. 19. A first annular groove 326 of the first annular VOA seal assembly 304 is L-shaped and has a bottom 332. For a nonlimiting example, the first annular groove may have the following cross-sectional dimensions: length G₁ equals about 0.280 inches, length G₂ equals about 0.048 inches, length G₃ equals about 0.222 inches, length G₄ equals about 0.059 inches and length G₅ equals about 0.058 inches. A first annular VOA seal 328 is L-shaped and received in the first annular groove 326. For a nonlimiting example, the first annular VOA seal may have the following cross-sectional dimensions: length S₁ equals about 0.14 inches, length S₂ equals about 0.044 inches, length S₃ equals about 0.083 inches, length S₄ equals about 0.056 inches and length S₅ equals about 0.062 inches. A wavy spring 330 at the bottom 332 of the first annular groove 326 provides biasing of the first annular VOA seal 328 toward the orbiter 104′. In this regard, a first contact face 334 of the first annular VOA seal 328 is inclined to a contact edge 334a which abuts a lower surface 336 of the orbiter 104′, as for example an incline height of 0.005 inches across the first contact face. The direction of pressure of compressed gas form the combustion chamber 114 is indicated by arrow C in FIG. 19.

A cross-sectional configuration common to the preferred second, third, fourth, fifth, sixth and seventh annular VOA seal assemblies 302, 310, 312, 316, 318, 324 is depicted at FIG. 20, wherein for the sake of brevity only the second radial VOA assembly 302 will be detailed, since the others are cross-sectionally identical. A second annular groove 338 is formed in the lower head 110′, has a bottom 340. For a nonlimiting example, the first annular groove may have the following cross-sectional dimensions: length G₁′ equals about 0.238 inches and length G₂′ equals about 0.048 inches. A second annular VOA seal 342 is rectangularly shaped and received in the second annular groove 338. For a nonlimiting example, the second annular VOA seal may have the following cross-sectional dimensions: length S₁′ equals about 0.145 inches, length S₂′ equals about 0.044 inches and S₃′ equals about 0.14 inches. A wavy spring 344 at the bottom 340 of the second annular groove 338 provides biasing of the second annular VOA seal 342 toward a surface 346 of the orbiter 104′. In this regard, a second contact face 348 of the second annular VOA seal 342 is inclined to a contact edge 348a which abuts the surface 346 of the orbiter 104′, as for example an incline height of 0.005 inches across the second contact face. The direction of pressure of compressed gas from the combustion chamber 114 is indicated by arrow C in FIG. 20.

A cross-sectional configuration common to the preferred first, second, third, fourth and fifth radial VOA seal assemblies 306, 308, 316, 318 and 324 is depicted at FIG. 21, wherein for the sake of brevity only the first radial VOA assembly 306 will be detailed, since the others are cross-sectionally identical. A radial groove 350 is formed in the lower head 110′ and has a bottom 352 and has, for example, cross-sectional dimensions roughly similar to that of the second annular groove. A radial VOA seal 354 is rectangularly shaped and received in the radial groove 350, and has cross-sectional dimensions roughly similar to that of the second annular VOA seal. A wavy spring 356 at the bottom 352 of the radial groove 350 provides biasing of the radial VOA seal 354 toward the orbiter 104′. In this regard, a third contact face 358 of the radial VOA seal 354 is inclined to a contact edge 358a which abuts the lower surface 358 of the orbiter 104′, as for example an incline height of about 0.005 inches across the second contact face. The direction of pressure of compressed gas from the combustion chamber 114 is shown by arrow C in FIG. 21.

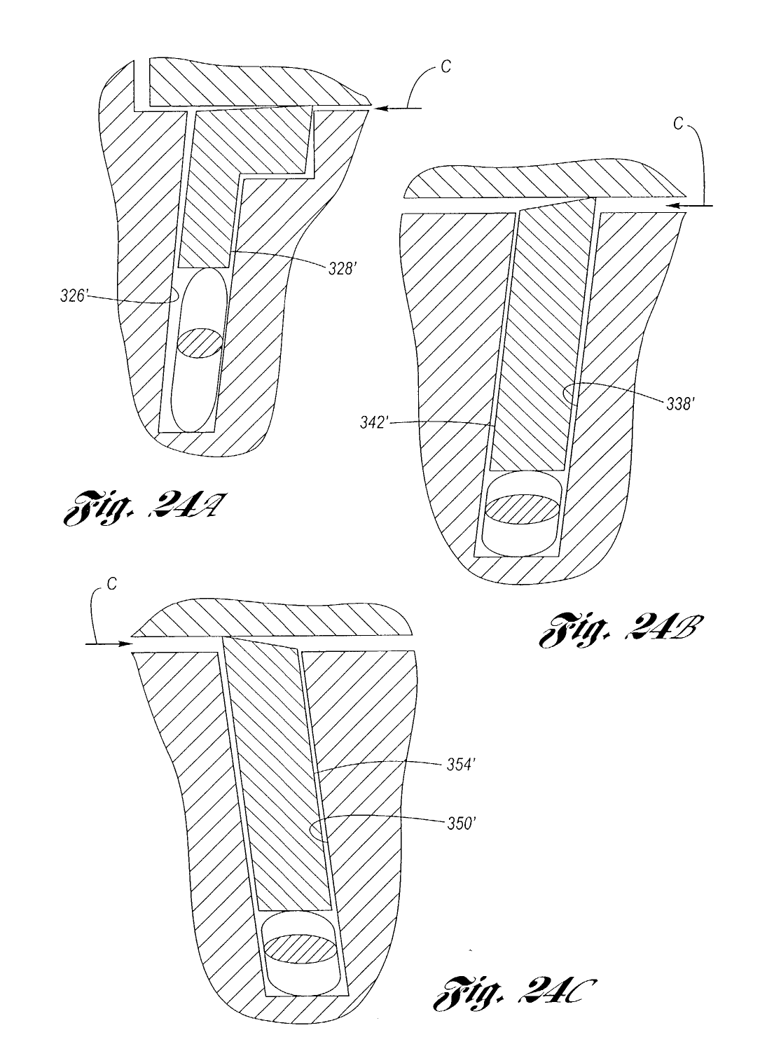

The ends of the radial VOA seals are preferably shaped so as to interlock, as for example as depicted at FIG. 23, with respectively transverse VOA seal assemblies (ie, the aforedescribed annular seal assembly 302 and the aforedescribed radial seal assembly 306). This interlocking will form a better seal at the intersection of the different VOA seals and will also prevent the VOA seals, and underlying wavy springs, from rotating in their respective grooves.

The first annular VOA seal assembly 304 is needed to prevent combustion products from escaping around the outer edge of the orbiter. The other annular VOA seal assemblies 302, 310, 312, 314, 320, 322 protect the thrust bearing on the upper head and prevent combustion products from leaking across the center of the orbiter into the intake or exhaust ports or into bearings around the orbiter shaft (top of orbiter only). The radial VOA seal assemblies 306, 308, 316, 318, 324 prevent mixing of intake and exhaust gases.

The VOA seals can be machined from cast steel or other metals, however, this is an expensive procedure. It is preferred for the VOA seals to be made from powder metallurgy processes and the wavy springs to be made from stainless steel wire formed into the spring in a manner similar to the way in which current wavy springs are manufactured.

Although coatings such as hard chrome with cast iron seals will provide a seal, the longevity of the surface, on account of wear, is in question. A new coating process developed at Lawrence Berkeley Laboratory (LBL) shows great promise for the VOA seals. The LBL coatings are metal oxides applied in very thin layers (5 to 10 microns) by a plasma gun. The thin layer coating would eliminate a machining process necessary to ensure coatings provide parallel surfaces on the orbiter. The thin layer added by the coating will be insignificant with respect to valve tolerances. These coatings are described in “New Coating Process Enables Higher-Efficiency Engines”, Berkeley Lab Research News, U.S. Dept. of Energy, Lawrence Berkeley National Laboratory, Berkeley, Calif., by Allan Chen, dated Aug. 26, 1996, hereby incorporated herein by reference. These coatings can provide protection of the orbiter, floater(s) and the VOA seals at high temperatures and they provide low friction operation with minimal wear, wherein lower temperature coatings have better friction and wear characteristics than the higher temperature variations. The VOA seal assemblies presented herein will work with many different materials and/or coatings; however, the LBL coating promises excellent wear capability provided by coating wear surfaces (the orbiter, floater(s) and the VOA seals), with the possibility up to 100,000 miles of engine operation with no lubricant between the orbiter and the VOA seals.

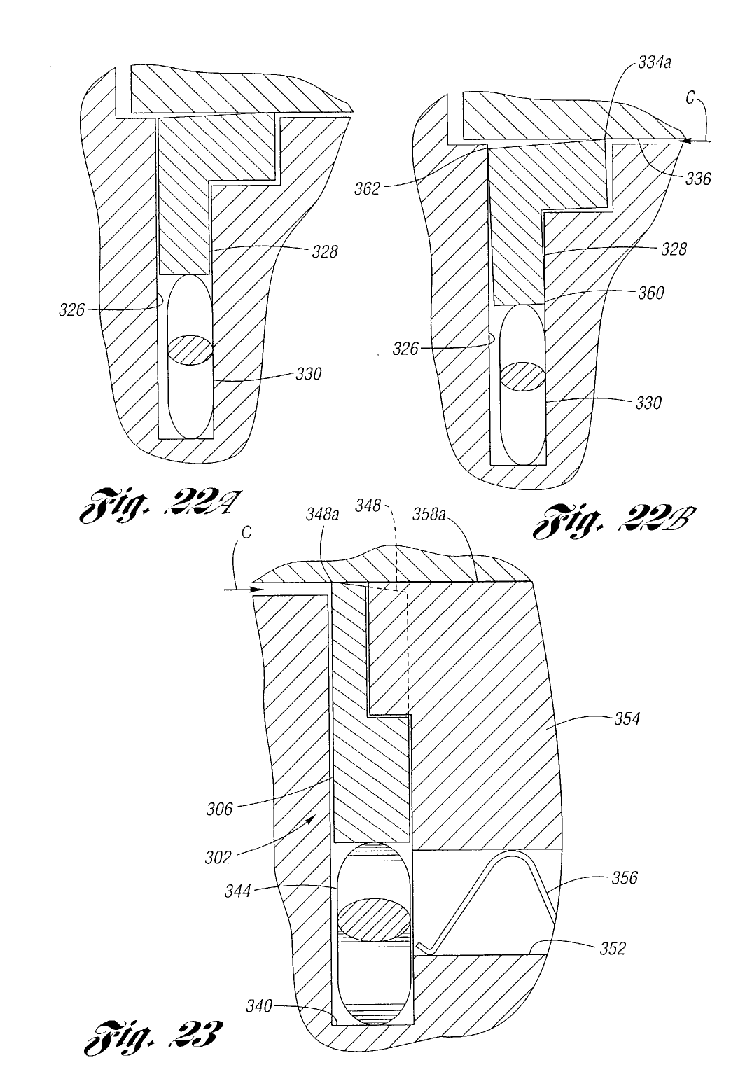

FIGS. 22A and 22B depict how the VOA seal assemblies seal when a compression or power stroke occurs in the combustion chamber 114, exemplified by the first annular VOA seal assembly 304. When compression of gas occurs along arrow C, the pressure of the compressed gas is applied at the rim 334a, which causes the first annular VOA seal 328 to become cocked so that, in addition to a primary sealing abutment of the rim 334a with the lower surface of 336 of the orbiter 104′, there is now a secondary sealing abutment between a lower edge 360 of the first annular VOA seal 328 against the annular groove 326 and a tertiary sealing abutment between an upper edge 362 of the VOA seal against the groove. The same sealing principle applies to any of the annular and radial VOA seal assemblies described hereinabove. By using a wavy spring to hold the VOA seals in contact with the orbiter, minimal force and minimal friction between the VOA seals and the orbiter is provided most of the time, wherein combustion pressure effects enhanced sealing.

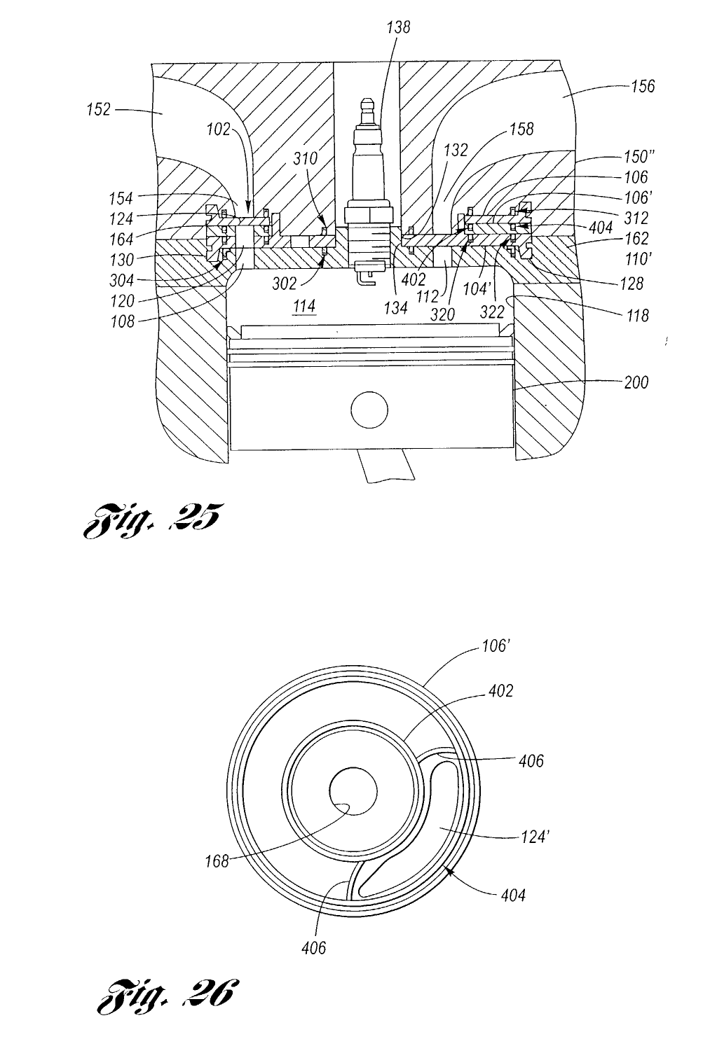

FIGS. 24A, 24B and 24C depict alternatives of the annular and radial VOA seal assemblies of FIGS. 19, 20 and 21, wherein the grooves 326′, 338′, 350′ are acutely angled toward the direction C of compressed gas, and the VOA seals 328′, 342′, 354′ are correspondingly configured. It is believed that by angling the VOA seals, the gas pressure will effect a tighter seal. FIG. 25 depicts a piston 200, cylinder 118 and combustion chamber 114 as shown at FIG. 14, wherein same parts have same reference numerals, and wherein the modification is inclusion of a second floater 106′, wherein a first floater 106 (identically the floater 106 of FIG. 14) is located between the upper head 150″ and the second floater. The fourth and fifth annular VOA seals 312, 314 of the upper head 150″ now abut the second floater 106′. As shown at FIG. 26, the second floater has eighth and ninth annular VOA seals 402, 404 and a pair of sixth radial VOA seals 406, each of which sealably abutting the first floater 106.

The advantages of the VOA seal assemblies include the following.

1. Effective sealing of the combustion chamber is provided.

2. Minimal friction will occur between the orbiter and the VOA seals (minimal power to rotate orbiter).

3. LBL coatings (discussed above) applied to the VOA seals and wear surfaces can be run dry and eliminate the contamination of the combustion chamber with lubricating oil through the valve mechanism (in contrast, poppet valves all leak lubricating oil through the valve guide seals).

4. LBL coatings applied to the VOA seals can potentially last for 100,000 miles or more of vehicle operation.

In view of the foregoing disclosure, it is to be understood that any of the relative moving interfaces between any of the floater or floaters, the orbiter, the upper head and the lower head as shown in Dubose may be sealed by a VOA seal assembly as described hereinabove, without the necessity of detailing herein every possible VOA valve system permutation.

To those skilled in the art to which this invention appertains, the above described preferred embodiment may be subject to change or modification. Such change or modification can be carried out without departing from the scope of the invention, which is intended to be limited only by the scope of the appended claims.

What is claimed is:

1. In a variable orbital aperture valve system of a fluid processing machine, comprising: an orbiter having at least one primary aperture therein; a lower head having at least one lower head port; an upper head having at least one upper head port; means for mounting said orbiter rotatably with respect to said upper and lower heads; at least one floater having a secondary aperture therein; and means for mounting said at least one floater adjacent said orbiter in movable relation to said orbiter; wherein the improvement thereto comprises a plurality of seal assemblies comprising:
a plurality of grooves formed in at least one of said orbiter, said upper head, said lower head, and said at least one floater, each groove being located opposite another of said orbiter, said upper head, said lower head and said at least one floater;
a plurality of seals, a seal respectively being received in each groove; and
biasing means located in each groove for biasing the seal received respectively therein outwardly with respect thereto such that said seal sealingly abuts the opposing other of said orbiter, said upper head, said lower head and said at least one floater.

2. The improvement of claim 1, wherein said biasing means comprises a plurality of wavy springs, one wavy spring respectively in each groove.

3. The improvement of claim 2, wherein each seal of said plurality of seals has an inclined contact surface terminating at a contact edge; wherein gas pressure applied in a predetermined direction to said plurality of seals adjacent the contact edge thereof causes said plurality of seals to tightly seal with respect to its respective groove and the opposing other of said orbiter, said upper head, said lower head and said at least one floater.

4. The improvement of claim 3, wherein each seal of said plurality of seals is coated with a low friction, high endurance coating.

5. The improvement of claim 4, wherein said plurality of seal assemblies comprises orbiter seal assembly means for sealing said orbiter with respect to at least one of said upper head, said lower head and said at least one floater, said orbiter seal assembly means comprising:
at least one first annular groove and at least one first annular seal respectively received therein for sealing an outer periphery of said orbiter with respect to at least one of said upper head, said lower head and said at least one floater.

6. The improvement of claim 5, wherein at least one first annular seal has an L-shaped cross-section and at least one said first annular seal has a similar L-shaped cross-section respectively received therein.

7. The improvement of claim 5, wherein said orbiter seal assembly means further comprises:
at least one second annular groove and at least one second annular seal respectively received therein for sealing an inner periphery of said orbiter with respect to one of said upper head, said lower head and said at least one floater.

8. The improvement of claim 7, wherein said orbiter seal assembly means further comprises:
a plurality of first radial grooves extending between said at least one first and second annular grooves; and
a plurality of first radial seals, one first radial seal for each first radial groove;
wherein said plurality of first radial seals seals said at least one primary aperture with respect to at least one of said at least one upper head ports, said at least one lower head ports and said secondary aperture of said at least one floater.

9. The improvement of claim 8, wherein said plurality of seal assemblies comprises floater seal assembly means for sealing said at least one floater with respect to at least one of said upper head, said lower head and said orbiter, said floater seal assembly means comprising:
at least one third annular groove and at least one third annular seal respectively received therein for sealing an outer periphery of said at least one floater with respect to at least one of said upper head, said lower head and said orbiter.

10. The improvement of claim 9, wherein said floater seal assembly means further comprises:
at least one fourth annular groove and at least one fourth annular seal respectively received therein for sealing an inner periphery of said at least one floater with respect to one of said upper head, said lower head and said orbiter.

11. The improvement of claim 10, wherein said radial seal assembly means further comprises:
a plurality of second radial grooves extending between said at least one first and second annular grooves; and
a plurality of second radial seals, one second radial seal for each second radial groove;
wherein said plurality of second radial seals seals said at least one primary aperture with respect to at least one of said at least one upper head ports, said at least one lower head ports and said primary aperture of said orbiter.
